(19) United States
(12) Patent Application Publication
(10) Pub. No.: US 2025/0313162 A1
(43) Pub. Date: Oct. 9, 2025

(54) ADJUSTABLE APPARATUS TO MOUNT ELECTRONIC DEVICES

(71) Applicant: Michael SHAIN, Conifer, CO (US)

(72) Inventor: Michael SHAIN, Conifer, CO (US)

(21) Appl. No.: 19/174,277

(22) Filed: Apr. 9, 2025

Related U.S. Application Data
(60) Provisional application No. 63/631,716, filed on Apr. 9, 2024.

(51) Int. Cl. B60R 11/02; B60R 11/00; G06F 1/16

(52) U.S. Cl. CPC B60R 11/0252; G06F 1/1607; B60R 2011/0084; B60R 2011/0085

(57) ABSTRACT

An apparatus to mount or attach an electronic device, includes: an elongate adjustable base configured to mount or attach the apparatus in a vehicle or other mobile or non-mobile work space; a leg member extending perpendicular to a longitudinal axis of the elongate adjustable base; and an articulating support structure fixed to the leg member, the articulating support structure including a first support member assembly supporting the electronic device, having at least one degree of freedom of movement and being releasably lockable in a locked position via at least one camlock.

### CROSS-REFERENCE TO RELATED APPLICATION(S)

This application claims priority under 35 U.S.C. § 119(e) to provisional U.S. patent application No. 63/631,716, filed Apr. 9, 2024, the entire contents of which are incorporated herein by reference.

### BACKGROUND

Computers, such as tablets and laptops, are increasingly being used outside of the office in non-traditional work settings, including motor vehicles. Motor vehicles being used as mobile work spaces may require electronic devices, such as computers, to be mounted in the passenger compartment in locations that are accessible to occupants of the front passenger compartment. This is particularly applicable to law enforcement, fire department and emergency medical services vehicles, but also applies to military, surveying, engineering and other technical mobile operations in motor vehicles.

### SUMMARY

Typical legacy mounting approaches require fixed brackets and locking arms requiring the manipulation of several locking nuts to make even the smallest adjustments. Movement from driver side functionality to passenger side functionality has been difficult and time consuming, requiring the mounts be dedicated and locked to one side or the other. These fixed brackets may also interfere with the deployment of airbags in a collision, because the mounts are locked in place.

In addition to the potential occlusion of airbags, the fixed and locked devices may prevent immediate access to emergency equipment and controls, such as emergency lights, sirens, radios, etc., and in law enforcement vehicles, may obstruct the interior of the vehicle in a way that prevents or may make it difficult to move through the interior of the vehicle in the event of an attack.

One or more example embodiments allow a device to be individually user adjusted for drag on the critical pivot and swing points, allowing the computer display, keyboard, and/or other electronic device, to be swiveled and/or tilted without releasing or unlocking any mechanism and yet hold the electronics securely enough that they can be used normally and safely, regardless of vehicle motion. One or more example embodiments also allow the optional locking of the mechanism.

According to one or more example embodiments, the user adjustable drag at the pivot and swing points is accomplished with the use of one or more fixed or adjustable camlocks that introduce incremental force to the two or more mating surfaces, arm-to-arm, arm-to-rod, etc. As the camlock is moved from one end of its range to the other, the camlock applies closing force to bring the two surfaces together, creating friction. The camlock, having an arc or range of motion, may be adjusted from the open position to the closed/locked position and anywhere in-between. The position within the range of the motion of the camlock dictates the amount of force, or drag the user can select. A mid-point position introduces medium friction, allowing the movement of the assembly without changing the position of the camlock.

The apparatus may be affixed by clamping or bolting base members and allows adjustability through multiple arms, rods and/or plates with pivoting and swiveling connections.

One or more example embodiments provide access and use of a computer or other electronic devices (e.g., in public safety vehicles) from the driver seat area and the passenger seat area without compromising the accessibility to safety equipment mounted inside the passenger compartment.

An adjustable apparatus to mount one or more electronic devices includes an adjustable base comprised of sliding bars, channels, brackets, braces, blocks and plates, connected by bolts, screws, clamps or clips, that may be clamped, screwed or bolted to vertical or horizontal surfaces, including vehicle seat rails and brackets, by the way of seat rail adapters, vehicle consoles, horizontal and/or vertical cylindrical or flat surfaces. One or more upright, (vertical) legs, which is/are part of the base, or bolted, welded or clamped to a tombstone, may have threaded, slotted or through holes that allow for the attachment of a single main plate, multiple plates or brackets by bolts, clamps or clips. The single plate, multiple plates or brackets, attached to the upright leg or legs, may incorporate apertures and/or slots or radiused clamping surfaces that allow round or square rods, which are captured by clamps, plates or by bolts, screws or clips, to project upward vertically and that may be adjusted in height by sliding, stepping or ratcheting. The rod(s) may have one or more pivoting arms, each having a horizontally or vertically disposed aperture that allows the use of a camming clamp or camlock to introduce friction to a single or multiple pivoting arms and/or rods.

The camming clamps have a radiused contact surface that introduces incrementally increasing clamping force to the two mating surfaces and are secured together by fasteners to each other.

The pivoting arm(s) or rod(s) may have through or threaded holes, clamps or clips that allow the attachment of torque hinges and/or torque pivots on the distal end of the arm(s) or rod(s) capable of engaging with an articulating element, tray and/or adapter plate.

The articulating element, tray and/or adapter plate may have a plurality of apertures that allows for the attachment of a computer, keyboard and/or other electronic devices.

One or more example embodiments provide an adjustable mounting assembly for attaching and supporting one or more electronic devices (or portions thereof) where the assembly supports the electronic device(s) in a position that is adjustable in the horizontal and vertical planes and allows access to the electronic device(s), when mounted in a vehicle, from the front passenger compartment of the vehicle, on either the driver or passenger side, or in a non-passenger compartment installation, allows access in all 360 degrees of adjustment/rotation. The apparatus attaches to seat rails/brackets, consoles, bulkheads, floors, and/or walls and allows an adjustable range of motion and articulation through connecting plates, hinges, pivots and/or arms.

At least one example embodiment provides an apparatus to mount or attach at least one electronic device, the apparatus including: an elongate adjustable base configured to mount or attach the apparatus in a vehicle or other mobile or non-mobile work space; a leg member extending perpendicular to a longitudinal axis of the elongate adjustable base; and an articulating support structure fixed to the leg member, the articulating support structure including a first support member assembly supporting at least a first portion of the at least one electronic device and a second support member assembly supporting at least a second portion of the at least one electronic device, each of the first support member assembly and the second support member assembly having at least one degree of freedom of movement and being releasably lockable in a locked position.

At least one example embodiment provides an apparatus to mount or attach an electronic device, the apparatus including: an elongate adjustable base configured to mount or attach the apparatus in a work space; a leg member extending perpendicular to a longitudinal axis of the elongate adjustable base; and an articulating support structure fixed to the leg member, the articulating support structure including a first support member assembly supporting the electronic device, having at least one degree of freedom of movement and being releasably lockable in a locked position via at least one camlock.

### BRIEF DESCRIPTION OF THE DRAWINGS

FIG. 1 is a perspective view of an example embodiment of an adjustable apparatus to mount electronic devices.

FIG. 2 is a side view of the adjustable apparatus shown in FIG. 1.

FIG. 3 is a rear view of the adjustable apparatus shown in FIG. 2.

FIG. 4 and FIG. 5 are views illustrating an example embodiment of an elongate adjustable base of the adjustable apparatus shown in FIGS. 1-3.

FIG. 6 is an exploded parts view of the adjustable apparatus shown in FIG. 1.

### DETAILED DESCRIPTION

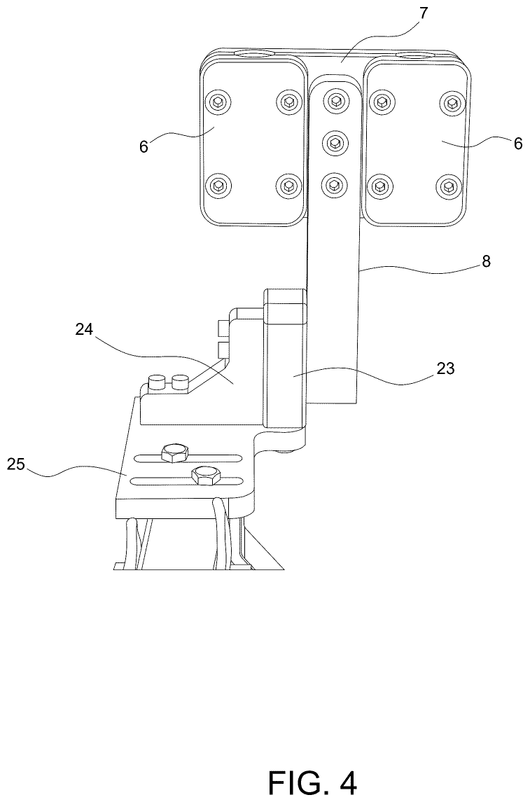

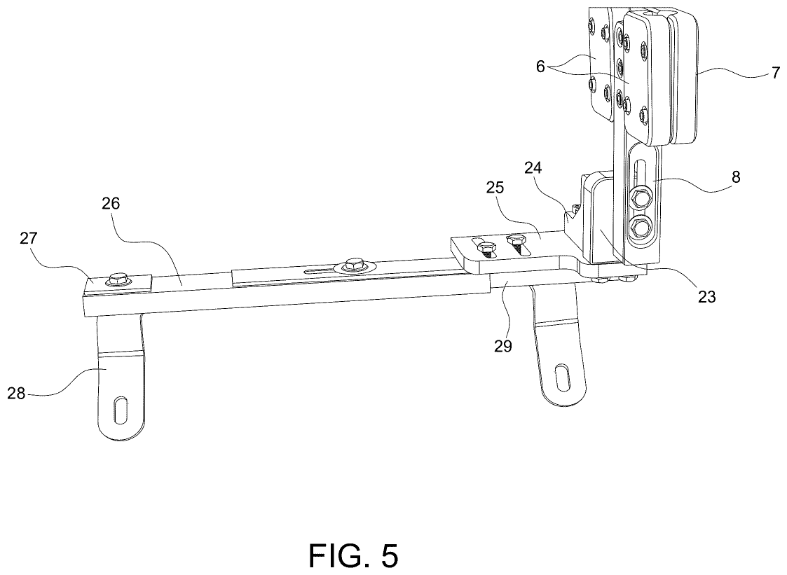

FIG. 4 is a side view of a leg and clamp assembly and a portion of an elongate adjustable base according to example embodiments. FIG. 5 is a front view of the elongate adjustable base according to example embodiments.

Referring to FIGS. 4 and 5, the apparatus includes an elongate adjustable base 23-29 configured to mount or attach the apparatus in a vehicle or other mobile or non-mobile work space. The apparatus further includes a leg and clamp assembly 6-8 fixed to the elongate adjustable base 23-29. The elongate adjustable base 23-29 includes telescoping sliding base bars 29 (also referred to as telescoping sliding bars or more simply base bars) having seat rail adapters 28 fixed thereto. The telescoping sliding base bars 29 are configured to adjust a length of the elongate adjustable base.

In more detail, the elongate adjustable base 23-29 includes a base bar 29 and a base channel 26 each having apertures and/or slots. The base bar 29 and the base channel 26 are secured to each other with screws, bolts or other fasteners that allow the components to slide axially relative to one another along the longitudinal axis of the elongate adjustable base 23-29. The base bar 29 and base channel 26 are also configured to engage with base blocks 27 and seat rail adapters 28 that have apertures and/or slots to attach the elongate adjustable base 23-29 to vehicle seats rails, bases and/or floors.

The elongate adjustable base 23-29 further includes brace and base plate assembly 24, 25 that movably fixes a leg member 8 to the telescoping sliding base bars 29. The brace and base plate assembly 24, 25 includes a base plate 25 and a brace 24. The brace and base plate assembly 24, 25 is configured to be adjusted to position the leg member 8 relative to the elongate adjustable base 23-29. The leg member 8 is configured to be positioned perpendicular or substantially perpendicular to the longitudinal axis of the elongate adjustable base 23-29. The leg member 8 may include one or more legs.

In more detail, the base bar 29 and base channel 26 assembly has apertures, either threaded or through holes, that allow for the attachment of the base plate 25 by screws, bolts or other fasteners. The base plate 25 has slots that provide lateral adjustability and other threaded or through holes that allow for attachment of a tombstone 23 and the brace 24 by screws, bolts or other fasteners.

The tombstone 23 has threaded or through holes or slots that allow for attachment of one or more legs of the leg member 8 of the leg and clamping assembly by screws, bolts or other fasteners. The one or more legs extend perpendicularly or substantially perpendicularly (e.g., upwards vertically) relative to the longitudinal axis of the elongate adjustable base. The one or more legs have a slot or slots that allow the one or more legs to slide and tilt in multiple axes.

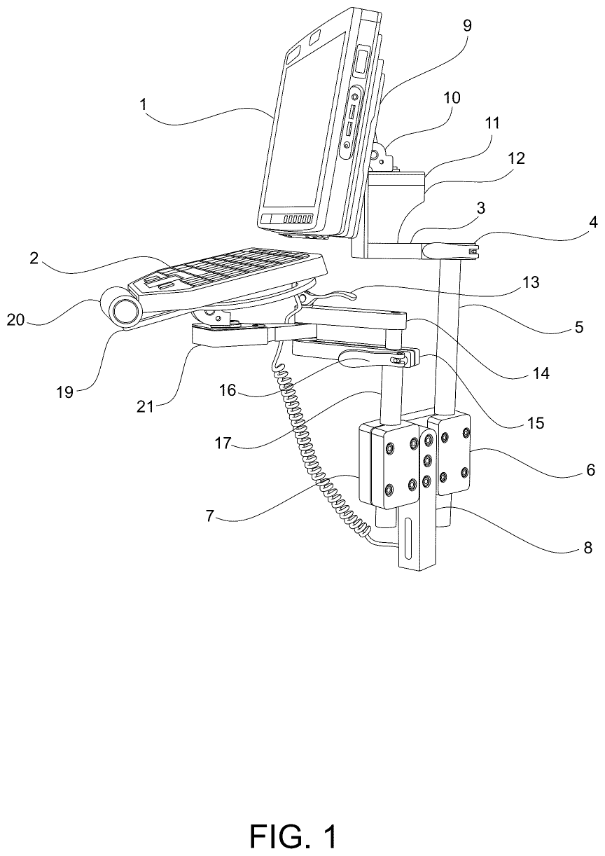

The one or more legs of the leg member 8 further include through holes or slots that allow for attachment, securing and carrying of a main plate 7 (first clamping member). The main plate 7 has radiused or slotted recesses configured to receive and hold one or more vertical support members 5 and 17 (also referred to as rods or vertical rods) to support an articulating support structure 3-4, 9-12, 13-16, 19-21 (FIGS. 1-3) including, among other elements, the one or more vertical support members 5 and 17. The one or more vertical support members 5 and 17 may include a display rod 5 and a keyboard rod 17.

The one or more vertical support members 5 and 17 are clamped and/or fixed in position by securing respective clamps 6 (second clamping members) by screws, bolts or other fasteners. The clamps 6 and the main plate 7 may be collectively referred to as a clamping assembly 6, 7.

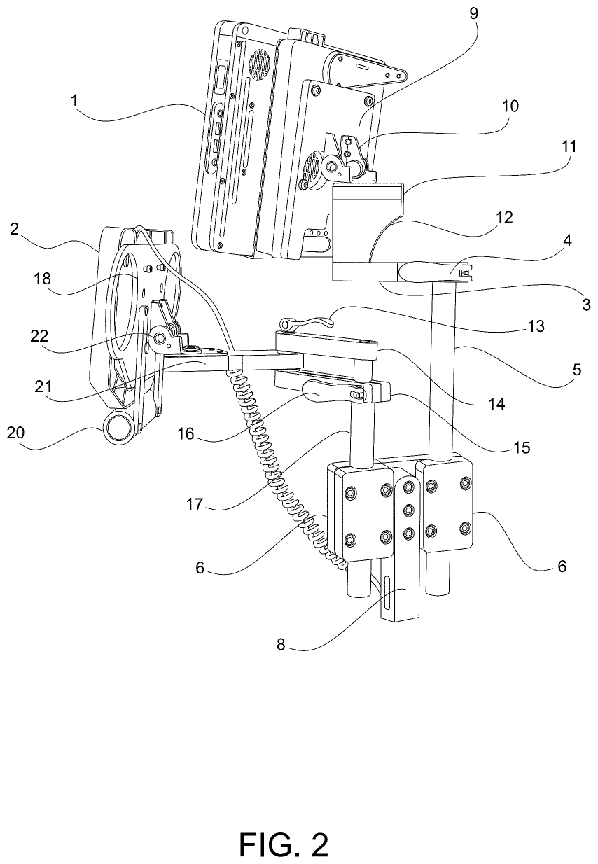

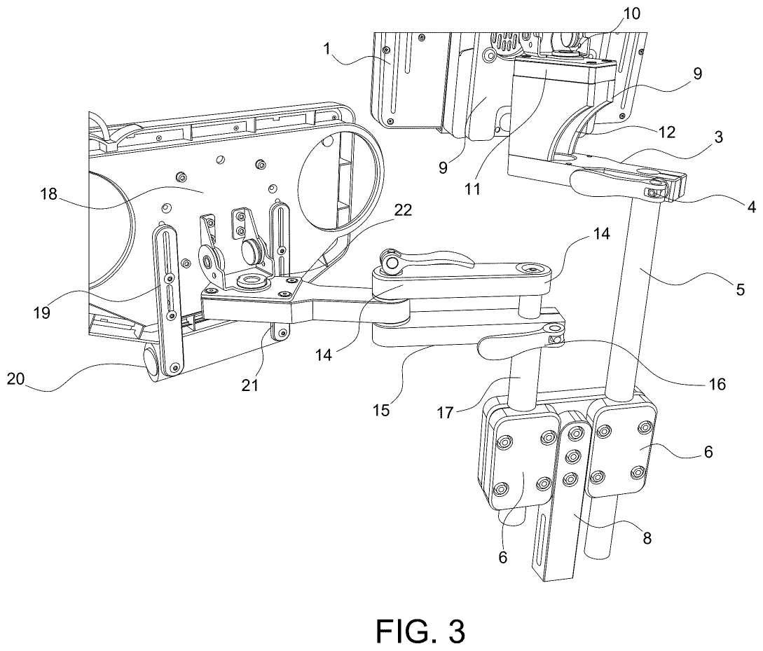

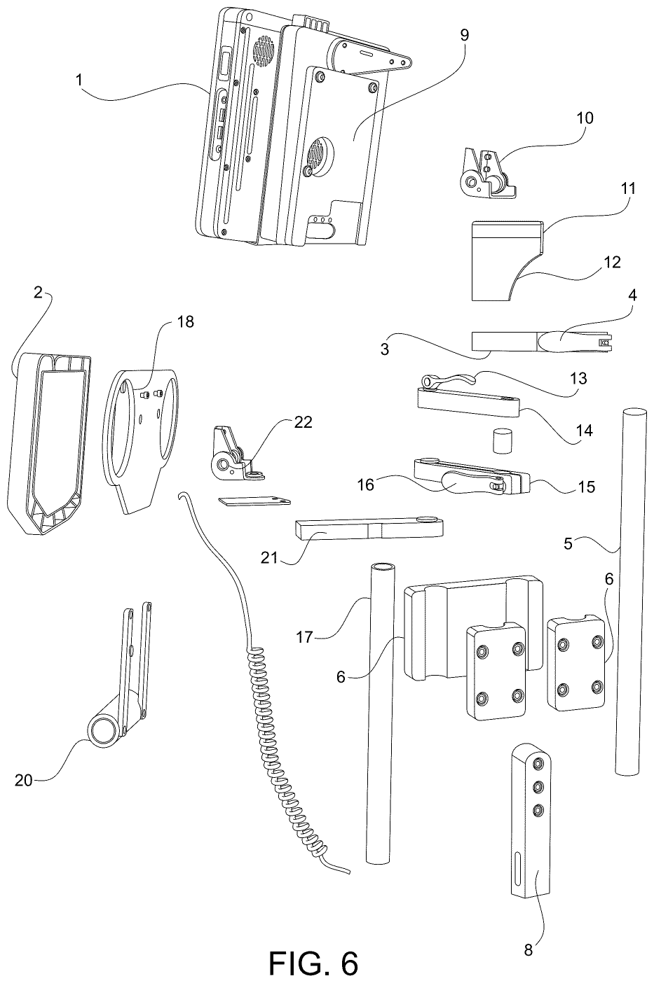

FIG. 1 is a perspective view of an example embodiment of an adjustable apparatus including an articulating support structure to mount one or more electronic devices. FIG. 2 is a side view of the adjustable apparatus shown in FIG. 1 with a tray (e.g., keyboard tray) tilted in the vertical position. FIG. 3 is a rear view of the adjustable apparatus shown in FIG. 2. FIG. 6 is an exploded parts view of the adjustable apparatus shown in FIG. 1.

Referring to FIGS. 1-3 and 6, the articulating support structure 3-4, 9-12, 13-16 and 19-21 includes a first support member assembly 13-16 and 19-21, supporting a first portion 2 of the at least one electronic device, and a second support member assembly 3-4 and 9-12 supporting a second portion 1 (e.g., a tablet or monitor) of the at least one electronic device. The first support member assembly 13-16 and 19-21, and the second support member assembly 3-4 and 9-12 are secured and held by the clamping assembly 6, 7. Each of the first support member assembly 13-16 and 19-21, and the second support member assembly 3-4 and 9-12 have at least one degree of freedom of movement and are releasably lockable in a locked position.

In more detail, for example, the first vertical support member 17 is secured in a first slotted recess of the clamping assembly 6, 7, and the second vertical support member 5 is secured in a second slotted recess of the clamping assembly 6, 7. The vertical support members 5 and 17 are adjustable rotationally and axially along the longitudinal axis of the respective support member.

A first horizontal support member 14, 15 has a first end at least rotatably connected to the first vertical support member 17 at a first pivot position by apertures, screws, bolts or other fasteners. The first horizontal support member 14, 15 is configured to rotate and/or pivot about an axis of rotation at the first pivot position. The axis of rotation is co-axial with a longitudinal axis of the first vertical support member 17

A second horizontal support member 21 has a first end at least rotatably connected to a second end of the first horizontal support member 14, 15 at a second pivot position by apertures, screws, bolts or other fasteners. The second horizonal support member 21 is configured to rotate and/or pivot relative to the first horizontal support member 14, 15 at the second pivot position.

A first electronic device fixing assembly 18-20, 22 is at least rotatably connected to a second end of the second horizontal support member 21 by apertures, screws, bolts or other fasteners. The first electronic device fixing assembly 18-20, 22 is configured to hold at least the first portion 2 (e.g., a keyboard) of the at least one electronic device. In another embodiment, the first electronic device fixing assembly 18-20, 22 may be configured to hold the entire electronic device (e.g., a laptop or tablet). The first electronic device fixing assembly 18-20, 22 is configured to rotate and/or pivot relative to the second horizontal support member 21.

The first support member assembly 13-16 and 19-22 further includes a first camlock 16 and/or a second camlock 13. The first camlock 16 is arranged at the first pivot position to inhibit and/or prevent rotation and/or pivoting of the first horizontal support member 14, 15 by introducing incremental friction as it is partially closed or when it is completely locked. The second camlock 13 is arranged at the second pivot position to inhibit and/or prevent rotation and/or pivoting of the second horizontal support member 21 relative to the first horizontal support member 14, 15 by introducing incremental friction as it is partially closed or when it is completely locked.

Still referring to FIGS. 1-3, a first adapter plate 18 is configured to hold the first portion 2 (e.g., keyboard) of the at least one electronic device. A first torque hinge 22 connects the first adapter plate 18 to the second end of the second horizontal support member 21. The first torque hinge 22 is attached to the second horizontal support member 21 by screws, bolts or other fasteners either directly (as shown in FIG. 1, for example) or with a transitional standoff 12 and hinge adapter 11. The standoff 12 and hinge adapter 11 may be reversable to allow extension of the first adapter plate 18. The standoff 12 may include an aperture or radiused profile to accommodate electronic cables or power cords as they move with the rotation and articulation of the first support member assembly 13-16 and 19-22. The first torque hinge 22 is configured to rotate and/or pivot relative to the second horizontal support member 21. The pivot motion may be perpendicular or substantially perpendicular to the axis of rotation of the first torque hinge 22.

The first torque hinge 22 includes threaded or through holes that allow for the attachment of the first adapter plate 18 (also referred to as a keyboard tray) by screws, bolts or other fasteners with the first adapter plate 18 having multiple apertures, threaded and/or through holes, slots, clamps, clips, pins or straps or other fasteners that accept and secure one or more electronic devices.

With regard to the second support member assembly 3-4 and 9-12, a third horizontal support member 3, 11, 12 includes a horizontal support arm 3 having a first end that is rotatably connected to the second vertical support member 5 at a third pivot position by apertures, screws, bolts or other fasteners. The third horizontal support member 3, 11, 12 is configured to pivot and/or rotate about an axis of rotation at the third pivot position. The axis of rotation is co-axial with a longitudinal axis of the second vertical support member 5.

The third horizontal support member 3, 11, 12 further includes a transitional stand off 12 and a hinge adapter 11 fixed at a second end of the horizontal support arm 3 by apertures, screws, bolts or other fasteners. The standoff 12 and hinge adapter 11 are reversable in relation to the horizontal support arm 3 to allow extension of the first adapter plate 18 to move the electronic device (or portion thereof) closer to the user. The standoff 12 may include an aperture or radiused profile to accommodate electronic cables or power cords as they move with the rotation and articulation of the second support member assembly 3-4 and 9-12.

The second support member assembly 3-4 and 9-12 includes a third camlock 4 arranged on the horizontal support arm 3 at the third pivot position to inhibit and/or prevent rotation and/or pivoting of the horizontal support arm 3 by introducing incremental friction as it is partially closed or when it is completely locked.

A second electronic device fixing assembly 9, 10 is rotatably and pivotably connected to a second end of the third horizontal support member 3, 11, 12 by apertures, screws, bolts or other fasteners. The second electronic device fixing assembly 9, 10 is configured to hold at least the second portion 1 of the at least one electronic device. The second electronic device fixing assembly 9, 10 is configured to pivot and/or rotate relative to the third horizontal support member 3, 11, 12.

The second electronic device fixing assembly 9, 10 includes a second adapter plate 9 (e.g., display adapter) and a second torque hinge 10. The second adapter plate 9 is configured to hold the second portion 1 of the at least one electronic device.

The second torque hinge 10 is attached to a second end of the horizontal support arm 3 by screws, bolts or other fasteners either directly (without) or with the transitional stand off 12 and hinge adapter 11 (as shown in FIG. 1, for example). The second torque hinge 10 is configured to rotate and/or pivot relative to the third horizontal support member 3, 11, 12. The pivot motion may be perpendicular or substantially perpendicular to the axis of rotation of the second torque hinge 10.

The second torque hinge 10 includes threaded or through holes that allow for the attachment of the second adapter plate 9 (also referred to as a display adapter) by screws, bolts or other fasteners with the second adapter plate 9 having multiple apertures, threaded and/or through holes, slots, clamps, clips, pins or straps or other fasteners that accept and secure one or more electronic devices.

Although example embodiments are described herein with regard to torque hinges and torque hinge adapters, example embodiments should not be limited to this example. Rather, one or more of the torque hinges and/or one or more of the torque hinge adapters may be omitted. In yet another example embodiment, one or more of the torque hinge adapters may be replaced by a mechanical pivoting hinge.

Although example embodiments are generally shown and described with regard to an articulating support structure having a first support member and a second support member, example embodiments should not be limited to this example. Rather, the articulating support structure may include one support member or more than two support members. In one example, to support an electronic device such as a laptop computer, the articulating support structure may include the first support member assembly 13-16 and 19-22 without the second support member assembly 3-4 and 9-12. Alternatively, the articulating support structure may include the second support member assembly 3-4 and 9-12 without the first support member assembly 13-16 and 19-22. Moreover, in this example, the first or second support member assembly may be secured to the elongate adjustable base via a clamping assembly having a single slot and clamp assembly.

One or more example embodiments provide articulating joints to allow for true 360 degree articulation, adjustment and/or movement. Additionally, the articulating joints allow for infinite adjustments within these 360 degrees, without set detents or increments of movement, allowing for sub-degree adjustments, to obtain improved individual personalization and/or performance.

One or more example embodiments allow for a complete range of adjustment from unlocked (movable) to locked and in between. The apparatus according to one or more example embodiments also allows for intermediate drag adjustment that facilitates placement and more stable use of the mounted electronic device(s), so that the devices are less affected by normal/typical vehicle use/movement, but may still be pushed/pulled to other locations/orientations within the vehicle without unlocking any hardware or re-adjusting the camlock assemblies. In at least some example embodiments, drag adjustments on pivoting assemblies 3-5, 14-17 and 13-15, 21 are accomplished by the progressive friction that camlock 13, causes when manipulated to draw the pivoting arms 14-15, 21, into progressively tighter contact with one another, or until they are sufficiently tight as to be locked in place. Drag adjustments on the rotational assemblies 14-15, 17 and 3,5, are accomplished by the progressive friction of camlocks 4 and 16, when manipulated to draw together the opposite sides of horizontal support arm 3, and upper cam arm 14, against the surface of display rod 5, and keyboard rod 17 into progressively tighter contact with one another, or until they are sufficiently tight as to be locked in place.

The intermediate drag adjustment condition also allows for a new level of user (e.g., law enforcement officer) safety that have an emergency need to move from one side of the vehicle to the other.

At least by virtue of the intermediate drag feature, the apparatus may also facilitate more rapid access to the controls in the center console of a law enforcement vehicle. By simply pushing, pulling or tilting, a user may gain access to the emergency vehicle controls located in the center console that are typically obstructed by the currently available mounts.

Conventional locking hardware requires that the user look down to locate and manipulate that locking hardware. The apparatus according to one or more example embodiments, allows the user to keep his/her head up and eyes on the situation, enhancing safety when moving the tablet/keyboard/laptop is necessary during a field contact.

The low profile and radiused components of the passenger side assembly allow for a passenger user to occupy the passenger seat without any obstructions to their legs or snagging risks of their equipment.

Illustrative embodiment 1. An apparatus to mount or attach at least one electronic device, the apparatus comprising: an elongate adjustable base configured to mount or attach the apparatus in a vehicle or other mobile or non-mobile work space; a leg member extending perpendicular to a longitudinal axis of the elongate adjustable base; and an articulating support structure fixed to the leg member, the articulating support structure including a first support member assembly supporting at least a first portion of the at least one electronic device and a second support member assembly supporting at least a second portion of the at least one electronic device, each of the first support member assembly and the second support member assembly having at least one degree of freedom of movement and being releasably lockable in a locked position.

Illustrative embodiment 2. The apparatus of illustrative embodiment 1, wherein the elongate adjustable base comprises: telescoping sliding bars having seat rail adapters fixed thereto, the telescoping sliding bars configured to adjust a length of the elongate adjustable base; and a brace and base plate assembly that movably fixes the leg member to the telescoping sliding bars.

Illustrative embodiment 3. The apparatus of illustrative embodiment 2, wherein the brace and base plate assembly is configured to move to position the leg member relative to the elongate adjustable base.

Illustrative embodiment 4. The apparatus of any of the preceding illustrative embodiments, wherein the leg member is configured to be positioned vertically relative to the elongate adjustable base.

Illustrative embodiment 5. The apparatus of any of the preceding illustrative embodiments, wherein the articulating support structure comprises: a clamping assembly configured to clamp the first support member assembly and the second support member assembly to the leg member.

Illustrative embodiment 6. The apparatus of illustrative embodiment 5, wherein the first support member assembly comprises: a first vertical support member held by the clamping assembly; a first horizontal support member having a first end rotatably connected to the first vertical support member at a first pivot position, the first horizontal support member being configured to at least one of pivot or rotate about an axis of rotation at the first pivot position, the axis of rotation being co-axial with a longitudinal axis of the first vertical support member; a second horizontal support member having a first end rotatably connected to a second end of the first horizontal support member at a second pivot position, the second horizontal support member being configured to at least one of pivot or rotate relative to the first horizontal support member at the second pivot position; and a first electronic device fixing assembly rotatably connected to a second end of the second horizontal support member, the first electronic device fixing assembly configured to hold at least the first portion of the at least one electronic device.

Illustrative embodiment 7. The apparatus of illustrative embodiment 6, wherein the first electronic device fixing assembly is configured to at least one of pivot or rotate relative to the second horizontal support member.

Illustrative embodiment 8. The apparatus of any of illustrative embodiments 6 or 7, wherein the first support member assembly comprises at least one of: a first camlock arranged at the first pivot position to prevent rotation of the first horizontal support member when locked; or a second camlock arranged at the second pivot position to prevent movement of the second horizontal support member relative to the first horizontal support member when locked.

Illustrative embodiment 9. The apparatus of any of illustrative embodiments 6-8, wherein the first electronic device fixing assembly comprises: a first adapter plate configured to hold the first portion of the at least one electronic device; and a first torque hinge connecting the first adapter plate to the second end of the second horizontal support member, the first torque hinge configured to at least one of pivot or rotate relative to the second horizontal support member.

Illustrative embodiment 10. The apparatus of any of illustrative embodiments 6-9, wherein the second support member assembly comprises: a second vertical support member held by the clamping assembly; a third horizontal support member having a first end rotatably connected to the second vertical support member at a third pivot position, the third horizontal support member being configured to at least one of pivot or rotate about an axis of rotation at the third pivot position, the axis of rotation being co-axial with a longitudinal axis of the second vertical support member; and a second electronic device fixing assembly rotatably connected to a second end of the third horizontal support member, the second electronic device fixing assembly configured to hold at least the second portion of the at least one electronic device.

Illustrative embodiment 11. The apparatus of illustrative embodiment 10, wherein the second electronic device fixing assembly is configured to at least one of pivot or rotate relative to the third horizontal support member.

Illustrative embodiment 12. The apparatus of any of illustrative embodiments 10-11, wherein the second support member assembly comprises: a third camlock arranged at the third pivot position to prevent rotation of the third horizontal support member when locked.

Illustrative embodiment 13. The apparatus of any of illustrative embodiment2 10-12, wherein the second electronic device fixing assembly comprises: a second adapter plate configured to hold the second portion of the at least one electronic device; and a second torque hinge connecting the second adapter plate to a second end of the third horizontal support member, the second torque hinge configured to at least one of pivot or rotate relative to the third horizontal support member.

Illustrative embodiment 14. The apparatus of any of illustrative embodiments 6-13, wherein the first support member assembly comprises at least one of: a first camlock arranged at the first pivot position, the first camlock configured to be manipulated to introduce friction incrementally to at least one of inhibit or prevent at least one of pivot or rotation of the first horizontal support member; or a second camlock arranged at the second pivot position, the second camlock configured to be manipulated to introduce friction incrementally to at least one of inhibit or prevent at least one of pivot or rotation of the second horizontal support member relative to the first horizontal support member.

Illustrative embodiment 15. The apparatus of any of the preceding illustrative embodiments, wherein the at least one electronic device includes a tablet computer with a keyboard.

Illustrative embodiment 16. The apparatus of any of the preceding illustrative embodiments, wherein the at least one electronic device includes a tablet or laptop computer.

Illustrative embodiment 17. An apparatus to mount or attach an electronic device, the apparatus comprising: an elongate adjustable base configured to mount or attach the apparatus in a work space; a leg member extending perpendicular to a longitudinal axis of the elongate adjustable base; and an articulating support structure fixed to the leg member, the articulating support structure including a first support member assembly supporting the electronic device, having at least one degree of freedom of movement and being releasably lockable in a locked position via at least one camlock.

Illustrative embodiment 18. The apparatus of illustrative embodiment 17, wherein the first support member assembly comprises: a first vertical support member held by a clamping assembly; a first horizontal support member having a first end rotatably connected to the first vertical support member at a first pivot position, the first horizontal support member being configured to at least one of pivot or rotate about an axis of rotation at the first pivot position, the axis of rotation being co-axial with a longitudinal axis of the first vertical support member; a second horizontal support member having a first end rotatably connected to a second end of the first horizontal support member at a second pivot position, the second horizontal support member being configured to at least one of pivot or rotate relative to the first horizontal support member at the second pivot position; and a first electronic device fixing assembly rotatably connected to a second end of the second horizontal support member, the first electronic device fixing assembly configured to hold the electronic device.

Illustrative embodiment 19. The apparatus of illustrative embodiment 18, wherein the first support member assembly comprises at least one of: a first camlock arranged at the first pivot position, the first camlock configured to be manipulated to introduce friction incrementally to at least one of inhibit or prevent at least one of pivot or rotation of the first horizontal support member; or a second camlock arranged at the second pivot position, the second camlock configured to be manipulated to introduce friction incrementally to at least one of inhibit or prevent at least one of pivot or rotation of the second horizontal support member relative to the first horizontal support member.

Illustrative embodiment 20. The apparatus of any of illustrative embodiments 17-19, wherein the work space is a vehicle or other mobile or non-mobile work space.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing embodiments. The present invention may, however, be embodied in many alternate forms and should not be construed as limited to only the embodiments set forth herein.

What is claimed:

1. An apparatus to mount or attach at least one electronic device, the apparatus comprising:
an elongate adjustable base configured to mount or attach the apparatus in a vehicle or other mobile or non-mobile work space;
a leg member extending perpendicular to a longitudinal axis of the elongate adjustable base; and
an articulating support structure fixed to the leg member, the articulating support structure including a first support member assembly supporting at least a first portion of the at least one electronic device and a second support member assembly supporting at least a second portion of the at least one electronic device, each of the first support member assembly and the second support member assembly having at least one degree of freedom of movement and being releasably lockable in a locked position.

2. The apparatus of claim 1, wherein the elongate adjustable base comprises:
telescoping sliding bars having seat rail adapters fixed thereto, the telescoping sliding bars configured to adjust a length of the elongate adjustable base; and
a brace and base plate assembly that movably fixes the leg member to the telescoping sliding bars.

3. The apparatus of claim 2, wherein the brace and base plate assembly is configured to move to position the leg member relative to the elongate adjustable base.

4. The apparatus of claim 1, wherein the leg member is configured to be positioned vertically relative to the elongate adjustable base.

5. The apparatus of claim 1, wherein the articulating support structure comprises:
a clamping assembly configured to clamp the first support member assembly and the second support member assembly to the leg member.

6. The apparatus of claim 5, wherein the first support member assembly comprises:
a first vertical support member held by the clamping assembly;
a first horizontal support member having a first end rotatably connected to the first vertical support member at a first pivot position, the first horizontal support member being configured to at least one of pivot or rotate about an axis of rotation at the first pivot position, the axis of rotation being co-axial with a longitudinal axis of the first vertical support member;
a second horizontal support member having a first end rotatably connected to a second end of the first horizontal support member at a second pivot position, the second horizontal support member being configured to at least one of pivot or rotate relative to the first horizontal support member at the second pivot position; and
a first electronic device fixing assembly rotatably connected to a second end of the second horizontal support member, the first electronic device fixing assembly configured to hold at least the first portion of the at least one electronic device.

7. The apparatus of claim 6, wherein the first electronic device fixing assembly is configured to at least one of pivot or rotate relative to the second horizontal support member.

8. The apparatus of claim 6, wherein the first support member assembly comprises at least one of:
a first camlock arranged at the first pivot position to prevent rotation of the first horizontal support member when locked; or
a second camlock arranged at the second pivot position to prevent movement of the second horizontal support member relative to the first horizontal support member when locked.

9. The apparatus of claim 6, wherein the first electronic device fixing assembly comprises:
a first adapter plate configured to hold the first portion of the at least one electronic device; and
a first torque hinge connecting the first adapter plate to the second end of the second horizontal support member, the first torque hinge configured to at least one of pivot or rotate relative to the second horizontal support member.

10. The apparatus of claim 6, wherein the second support member assembly comprises:
a second vertical support member held by the clamping assembly;
a third horizontal support member having a first end rotatably connected to the second vertical support member at a third pivot position, the third horizontal support member being configured to at least one of pivot or rotate about an axis of rotation at the third pivot position, the axis of rotation being co-axial with a longitudinal axis of the second vertical support member; and
a second electronic device fixing assembly rotatably connected to a second end of the third horizontal support member, the second electronic device fixing assembly configured to hold at least the second portion of the at least one electronic device.

11. The apparatus of claim 10, wherein the second electronic device fixing assembly is configured to at least one of pivot or rotate relative to the third horizontal support member.

12. The apparatus of claim 10, wherein the second support member assembly comprises:
a third camlock arranged at the third pivot position to prevent rotation of the third horizontal support member when locked.

13. The apparatus of claim 10, wherein the second electronic device fixing assembly comprises:
a second adapter plate configured to hold the second portion of the at least one electronic device; and
a second torque hinge connecting the second adapter plate to a second end of the third horizontal support member, the second torque hinge configured to at least one of pivot or rotate relative to the third horizontal support member.

14. The apparatus of claim 6, wherein the first support member assembly comprises at least one of:
a first camlock arranged at the first pivot position, the first camlock configured to be manipulated to introduce friction incrementally to at least one of inhibit or prevent at least one of pivot or rotation of the first horizontal support member; or
a second camlock arranged at the second pivot position, the second camlock configured to be manipulated to introduce friction incrementally to at least one of inhibit or prevent at least one of pivot or rotation of the second horizontal support member relative to the first horizontal support member.

15. The apparatus of claim 1, wherein the at least one electronic device includes a tablet computer with a keyboard.

16. The apparatus of claim 1, wherein the at least one electronic device includes a tablet or laptop computer.

17. An apparatus to mount or attach an electronic device, the apparatus comprising:
an elongate adjustable base configured to mount or attach the apparatus in a work space;
a leg member extending perpendicular to a longitudinal axis of the elongate adjustable base; and
an articulating support structure fixed to the leg member, the articulating support structure including a first support member assembly supporting the electronic device, having at least one degree of freedom of movement and being releasably lockable in a locked position via at least one camlock.

18. The apparatus of claim 17, wherein the first support member assembly comprises:
a first vertical support member held by a clamping assembly;
a first horizontal support member having a first end rotatably connected to the first vertical support member at a first pivot position, the first horizontal support member being configured to at least one of pivot or rotate about an axis of rotation at the first pivot position, the axis of rotation being co-axial with a longitudinal axis of the first vertical support member;
a second horizontal support member having a first end rotatably connected to a second end of the first horizontal support member at a second pivot position, the second horizontal support member being configured to at least one of pivot or rotate relative to the first horizontal support member at the second pivot position; and
a first electronic device fixing assembly rotatably connected to a second end of the second horizontal support member, the first electronic device fixing assembly configured to hold the electronic device.

19. The apparatus of claim 18, wherein the first support member assembly comprises at least one of:
a first camlock arranged at the first pivot position, the first camlock configured to be manipulated to introduce friction incrementally to at least one of inhibit or prevent at least one of pivot or rotation of the first horizontal support member; or
a second camlock arranged at the second pivot position, the second camlock configured to be manipulated to introduce friction incrementally to at least one of inhibit or prevent at least one of pivot or rotation of the second horizontal support member relative to the first horizontal support member.

20. The apparatus of claim 17. wherein the work space is a vehicle or other mobile or non-mobile work space.
